(19) United States
(12) Patent Application Publication
(10) Pub. No.: US 2015/0147458 A1
(43) Pub. Date: May 28, 2015

(54) PROCESSED FOOD COMPOSITIONS TO FACILITATE INDEPENDENT AND DIGNIFIED DINING

(71) Applicants: Sarah E. Gorham, Atlanta, GA (US); Debra Stone Morris, Atlanta, GA (US)

(72) Inventors: Sarah E. Gorham, Atlanta, GA (US); Debra Stone Morris, Atlanta, GA (US)

(21) Appl. No.: 14/549,728

(22) Filed: Nov. 21, 2014

Related U.S. Application Data
(60) Provisional application No. 61/908,302, filed on Nov. 25, 2013.

(51) Int. Cl. A23L 1/29; A47J 43/07

(52) U.S. Cl. CPC A23L 1/296; A47J 43/07; A23V 2002/00
USPC 426/615; 426/531; 426/656; 425/202

(57) ABSTRACT

Methods and systems for preparing a processed food composition that is sized and shaped to facilitate independent dining are presented. A method, in one embodiment, includes selecting cooked menu items, combining them using a grinder or food processor into a mixture, and then shaping the mixture into a processed food composition that includes one or more substantially graspable sizes and shapes. The cooked menu items selected for mixing may include protein, carbohydrate, and/or vegetable, producing a food composition that is substantially nutritionally balanced. The system may include a food processor, such as a grinder or mixer, and a shaping tool for forming the combined foods into desired shapes and sizes.

### CROSS-REFERENCE TO RELATED APPLICATIONS

This application claims the benefit of U.S. Provisional Application 61/908,302, entitled “Processed Food Compositions To Facilitate Independent And Dignified Dining,” filed Nov. 25, 2013, which is incorporated herein by reference in its entirety.

### BACKGROUND

Certain disclosed embodiments relate to a food preparation and, more particularly, to a method of transforming one or more cooked menu items into a nutritionally complete processed food composition that is sized and shaped to facilitate independent dining, especially for persons with physical or cognitive impairments.

Residential care facilities face an increasing population of residents who have physical or cognitive impairments that make it difficult for them to use utensils and/or eat without assistance. Residents with neuromuscular or other physical limitations may have difficulty using utensils, cutting and manipulating foods to the mouth, chewing whole foods, and/or swallowing properly. Those with cognitive or memory impairments may be overwhelmed by the eating task, causing increased anxiety, reduced appetite, and weight loss. Many facilities accommodate such residents by preparing entirely separate foods for them or by providing a personal assistant at every meal. When a resident loses the ability to eat independently, many facilities resort to serving them blended or puréed foods, similar to baby food.

Many of the available foods that are suitable for such residents, such as pre-packaged bite-sized finger foods, are lacking in taste, variety, and basic nutrition. Buying separate foods also represents an additional expense and a preparation burden for dining personnel. Processed foods like chicken nuggets and fish sticks are not only expensive but also viewed as inferior, humiliating, and lacking in nutrition. Moreover, eating foods that are different from the regular menu items being eaten by others can contribute to a sense of exclusion or isolation others and, thus, can result in a decrease in overall health and resident satisfaction.

Hiring a personal assistant for each impaired resident at every meal also represents a significant additional expense for facilities and families. Visitors and family members sometimes share the burden, but often lack the training and skill to assist effectively. Requiring help at meal times can also contribute to a sense of exclusion or isolation from others and, thus, can also result in a decrease in overall health and resident satisfaction.

In addition to concerns about overall resident satisfaction and independence, many residential care facilities and institutions are increasingly concerned about supporting and maintaining patient dignity and choice. Federal and state laws and regulations enacted to protect disabled persons and seniors are beginning to describe the obligation to provide reasonable accommodations for such persons not only in terms of promoting basic health and safety, but also in terms of promoting dignity.

Thus, there is a need in the art for improved food preparation techniques that offer a more nutritionally balanced meal that can be eaten with more independence and dignity.

### SUMMARY

A method of preparing a processed food composition that is sized and shaped to facilitate independent dining is described. According to particular embodiments, the method includes selecting one or more cooked menu items, and combining the one or more cooked menu items into a mixture, and shaping the mixture into a processed food composition that includes one or more substantially graspable sizes and shapes.

The step of selecting may include selecting, from among the cooked menu items, one or more proteins, carbohydrates, and/or vegetables such that the processed food composition is substantially nutritionally balanced according to dietary principles. The step of selecting foods that produce a processed food composition having a protein component in an amount between about 30% to about 60% of the total weight, a carbohydrate component in an amount equal to between about 20% to about 40% of the total weight, and a vegetable component in an amount equal to between about 20% to about 40% of the total weight of the processed food composition.

The step of combining may include one or more food-processing techniques selected from the group consisting of grinding, chopping, blending, shredding, mixing, stirring, puréeing, grating, crushing, and slicing.

The step of shaping may include one or more techniques selected from the group consisting of spooning, scooping, molding, wrapping, shaping by hand. The step of shaping may produce one or more substantially graspable sizes and shapes selected from the group consisting of balls, spheres, egg-shapes, cubes, chunks, cylinders, sticks, strips, and slices. The processed food composition may be eaten substantially without utensils and without assistance.

In another aspect, according to particular embodiments, a system for preparing a processed food composition for independent dining, includes (1) one or more cooked menu items; (2) a food processor for combining the one or more cooked menu items into a mixture; and (3) a shaping tool for forming the mixture into a processed food composition comprising one or more substantially graspable sizes and shapes.

The system may include a guide for proportionally selecting the protein, carbohydrate, and vegetable foods such that the processed food composition is substantially nutritionally balanced according to dietary principles. For example, the system may produce a processed food composition having a protein food in an amount equal to between about 30% to about 60% of the total weight of the processed food composition, a carbohydrate food in an amount equal to between about 20% to about 40% of the total weight, and a vegetable food in an amount equal to between about 20% to about 40% of the total weight.

The food processor may include one or more tools selected from the group consisting of a grinder, chopper, blender, shredder, mixer, grater, crasher, and slicer. The shaping tool may include one or more tools selected from the group consisting of a spoon, scoop, mold, wrap, and hands. The shaping tool may produce one or more substantially graspable sizes and shapes including, for example, balls, spheres, egg-shapes, cubes, chunks, cylinders, sticks, strips, and slices. The system may produce a processed food composition which may be eaten substantially without utensils and without assistance.

Other apparatuses, methods, systems, features, and advantages of the disclosed embodiments will be apparent to one of ordinary skill in the art upon examination of the following figures and detailed description. All such additional apparatuses, methods, systems, features, and advantages are intended to be included within this description and to be included within the scope of the accompanying claims.

### BRIEF DESCRIPTION OF THE DRAWING

Features of the various embodiments disclosed will become more apparent in the detailed description, in which reference is made to the appended drawing, wherein:

FIG. 1 is an illustration of a method of preparing a processed food composition, according to various embodiments.

FIG. 2 is an illustration of a system for preparing a processed food composition, according to various embodiments.

Corresponding reference numbers indicate corresponding parts or elements throughout the several views of the drawing.

### DETAILED DESCRIPTION

The present systems and apparatuses and methods are understood more readily by reference to the following detailed description, examples, drawings, and claims. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

Like parts are marked throughout the following description and/or drawings with the same reference numerals. The drawings may not be to scale and certain features may be shown exaggerated in scale or in somewhat schematic format in the interest of clarity, conciseness, and to convey information.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof

As used throughout, the singular forms “a,” “an” and “the” include plural referents unless the context clearly dictates otherwise. Thus, for example, reference to a component can include two or more such components unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

### Method

In one aspect, the present invention includes a method of transforming one or more cooked menu items into a processed food composition that is sized and shaped to facilitate independent dining. In one embodiment, the method includes selecting one or more cooked menu items, combining them (using a grinder or food processor, for example) into a mixture, and then shaping the mixture into a processed food composition that includes one or more sizes and shapes that are readily graspable and easily eaten by hand without the need for utensils. Preferably, the processed food composition is substantially nutritionally balanced according to generally accepted dietary principles.

In a residential care or institutional setting, for example, the cooked menu items may include one or more of the foods already prepared for the majority of residents. Selecting these cooked menu items to be combined, according to particular embodiments of the method, means that the residents with physical or cognitive impairments may eat the same food as the other residents.

In addition to providing an inclusive and dignified dining experience for the impaired residents, the use of cooked menu items eliminates the time, expense, and delay associated with planning, preparing, and serving a completely separate meal for impaired residents.

The task of selecting one or more cooked menu items may include selecting a desired proportion of foods from one or more food groups. According to particular embodiments, the processed food composition created using the method described herein is substantially nutritionally balanced in accordance with generally accepted dietary principles and guidelines, such as the USDA Healthy Plate. For example, a processed food composition that is described as being composition weighing a total of 11 ounces, for example, may include 3 ounces of protein, 4 ounces of carbohydrate, and 4 ounces of vegetables. According to particular embodiments, a processed food composition as described herein may include:
Cooked Ground Proteins=between about 30% to about 60% of the total weight of the processed food composition.
Cooked Ground Carbohydrate=between about 20% to about 40% of the total weight of the processed food composition.
Cooked Ground Vegetables=between about 20% to about 40% of the total weight of the processed food composition.
   The meal, as a whole, may include a separate serving of milk or other dairy product and/or fruit, which is not part of the processed food composition.

In a related aspect, vitamins and nutritional supplements may be easily added to the food composition during the combining process to further add to or alter the nutritional balance of a meal.

Combining the selected cooked menu items, in one embodiment, includes grinding the items using a standard electric food grinder using a variety of grinder plates, blades, dies, and accessories. Unlike blending or puréeing, grinding cooked foods allows the user to select and control a desired texture. For cooked proteins, grinding helps break down the connective tissue, making the food more digestible and easier to chew, while retaining a preferred and desirable texture. Cooked and ground foods are easier to chew, reducing choking risk, and are more easily digested. According to the method described herein, one or more cooked menu items may be selected and combined to produce a processed food composition that has a familiar and pleasing texture, but requires little or no chewing.

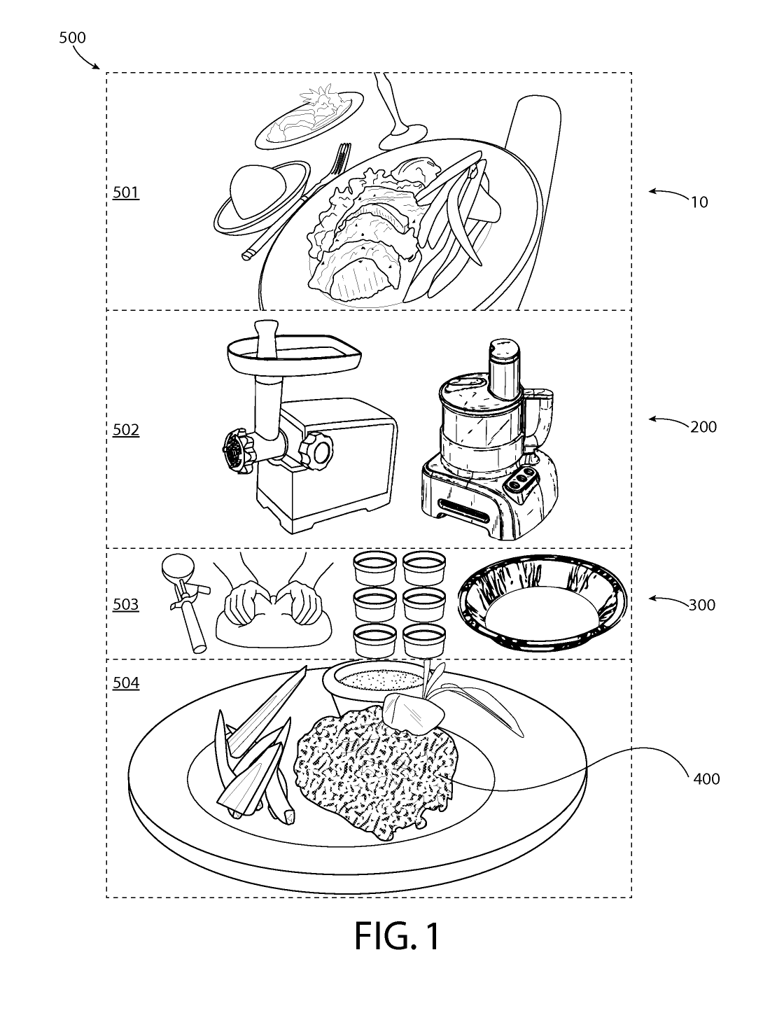

The cooked menu items may be ground separately or together, in any desired proportion or combination, to produce a desired processed food composition. For example, FIG. 1 is an illustration of a method of preparing a processed food composition, according to particular embodiments. The elements shown in FIG. 1 include one or more cooked menu items 10, a food processor 200 such as a grinder or food mill, one or more food shaping tools 300, and a processed food composition 400.

The method 500 may begin with Step 501, selecting one or more foods to be mixed, from among the one or more cooked menu items 10. For example, the step of selecting may include selecting a portion of a protein food (such as part or all of the roasted turkey portion shown in FIG. 1), selecting a carbohydrate food (such as part or all of the stuffing or dressing, or additional carbohydrates such as bread crumbs, if desired), and selecting a vegetable food (such as part or all of the green beans or other vegetables from among the cooked menu items 10). The portions may be selected so that the resulting processed food composition 400 is substantially nutritionally balanced. The processed food composition 400 may or may not include all three categories of foods because, in some embodiments, the vegetables or other foods are already sized and shaped for easy grasping, handling, and eating.

Step 502 includes combining the selected foods into a mixture, using one or more food processing tools available in a kitchen, such as the tools 200 shown in FIG. 1. Grinding is only one example of the food-processing techniques that may be useful in practicing the disclosed methods. The step of combining may include one (or several) food-processing techniques, including grinding, chopping, blending, shredding, mixing, stirring, puréeing, grating, crushing, or slicing. Any of a variety of desired processed food compositions may be made using these techniques.

Step 503 includes shaping the resulting mixture into a processed food composition 400 for serving in the form of one or more substantially graspable sizes and shapes. As shown, the composition 400 may be one or more bite-sized cubes or chucks that is easily to grasp, handle, and chew. The plate, as shown, may include additional servings of vegetable, fruit, sauces or gravy, or other menu items 10 that were not selected for mixing.

Shaping the combined foods into a graspable shape may be accomplished using any of a variety of food preparation techniques. The step of shaping, for example, may be accomplished by shaping the foods using a spoon or scoop, placing the combined foods into a mold (such as a ramekin, pie plate, or other dish), placing the combined foods into a wrap such as a pastry shell or tortilla, or shaping the foods by hand into a desired size and shape. The processed food composition may include one (or several) pieces, in a variety of desired shapes and sizes. For example, the processed food composition may include one or more balls or chunks that are readily graspable and easy to handle without utensils. Other graspable shapes may be used, such as cylinders, sticks, or strips. Combining foods into sizes and shapes that are easily grasped and/or bite-sized encourages self-feeding, without requiring utensils or a personal assistant, and thereby promotes a more dignified and independent dining experience. Any of a variety of food preparation techniques may be used to shape the combined foods into a desired size and shape. In this aspect, the step of shaping the combined and cooked menu items, according to particular embodiments, produces a nutritionally complete processed food composition that is readily graspable and easily eaten by hand.

In another aspect, the processed food composition may be prepared with only a minimal or nominal amount of additional time and effort, relative to the time and effort required to prepare the cooked menu items. Combining cooked menu items according to the method can be accomplished quickly and easily, using typically available kitchen tools such as a grinder, as described herein. In a related aspect, the processed food composition may be prepared by relatively unskilled personnel who receive minimal training.

The method, in a particular embodiment, may be performed in a kitchen by skilled or unskilled food preparation personnel. In other embodiments, part or all of the method may be performed using automated machines, either in a kitchen or in a manufacturing setting. The method, for example, may be automated such that the cooked menu items are selected for mixing, combined into a mixture using one or more machines, and shaped using one or more machines in order to produce a processed food composition, in relatively large quantities, that is ready for packaging and distribution as a grocery or specialty food item.

### System

In another aspect, the present invention includes a system for transforming one or more cooked menu items into a processed food composition that is sized and shaped to facilitate independent dining. In one embodiment, the system includes one or more cooked menu items, a food processor for combining selected foods, and a shaping tool for forming the combined food composition into one or more substantially graspable sized and shapes. The system may also include a training program for food service personnel. The training program, according to particular embodiments, may include a plurality of recipes and plating guidelines. The training program may include a program overview with goals, menus, recipes, plating guidelines, portion sizes, production charts, and service standards. The recipes may include instructions for selecting one or more cooked menu items, combining the selected menu items into a processed food composition using the food processor, and shaping the combined food composition into one or more substantially graspable sized and shapes.

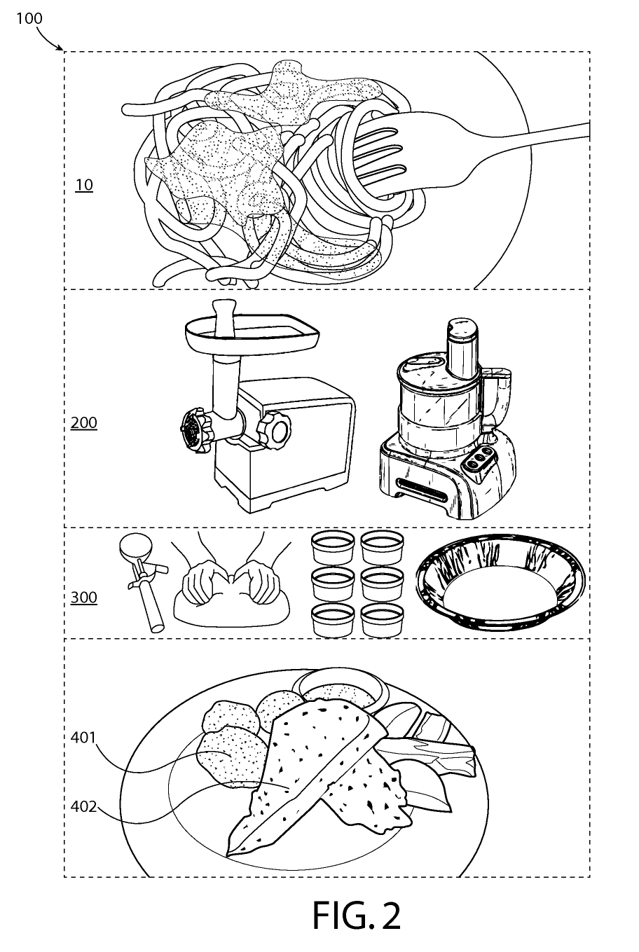

FIG. 2 is an illustration of a system for preparing a processed food composition, according to a particular embodiment. The system 100 may include one or more cooked menu items 10, a food processor 200 such as a grinder or food mill, one or more food shaping tools 300, and one or more processed food compositions.

The food processor 200, as described herein, may include any of a variety of different food-processing devices such as a grinder, chopper, blender, food processor, food mill, shredder, mixer, grater, crusher, or slicer. The food processor 200 may also include any of a variety of manual tools, such as knives, which are commonly used in food preparation.

The shaping tool 300, as described herein, may include a spoon or a scoop, a mold (such as a ramekin, pie plate, or other dish), or a wrap such as a pastry shell or tortilla, or any of a variety of other kitchen tools commonly used in food preparation. The shaping tool 300 may also include the preparer's hands, for shaping the foods into a desired size and shape.

In the example illustrated in FIG. 2, the one or more cooked menu items 10 may include spaghetti, sauce (with or without meat), meat balls, and one or more vegetables. FIG. 2 illustrates how the method and system, described herein, may be applied in two ways to a single set of cooked menu items 10 and produce two different processed food compositions.

A first processed food composition 401—the meat balls on the plate—may include a protein, a carbohydrate, and/or a vegetable. Pre-packaged meat balls, for example, among the set of cooked menu items 10, may or may not be nutritionally complete. The food preparer may select the packaged meat balls, a portion of the sauce, a portion of the spaghetti (a carbohydrate), and/or a portion of the vegetables—in order to create meats balls for the plate that have an improved nutritional balance. The selected foods may be mixed, using the grinder or other food processor 200, and then shaped by hand (one of the shaping tools 300) into a round or ball shape. The resulting meat balls for the plate represent a first processed food composition 401 that has improved nutritional balance, compared to the packaged meat balls alone.

A second processed food composition 402—the wedges shown on the plate—may include a protein, a carbohydrate, and/or a vegetable. The food preparer may select a portion of the packaged meat balls (a protein), a portion of the sauce, a portion of the spaghetti (a carbohydrate), and/or a portion of the vegetables. An additional protein component, such as egg or egg white, may be added to the mixture. The selected foods may be mixed, using the grinder or other food processor 200, and then shaped into a pie plate or another of the shaping tools 300, and then sliced into easily graspable wedges. The resulting wedges for the plate represent a second processed food composition 402 that has improved nutritional balance, compared to the spaghetti noodles alone.

In this aspect, the methods and systems may be applied to a single set of cooked menu items 10 in order to produce two separate processed food compositions 401, 402, each having a desired nutritional balance as well as being shaped into one or more graspable sizes and shapes. Some people may not eat all the foods on an entire plate; instead eating only one or two of the processed food compositions 401, 402. In this aspect, creating a processed food composition that is nutritionally complete by itself, without relying on other foods, helps facilitate the delivery of proper nutrition.

The system 100, in a particular embodiment, may be used in a kitchen setting by skilled or unskilled food preparation personnel. In other embodiments, part or all of the system 100 may be performed using automated machines, either in a kitchen or in a manufacturing setting. The system, for example, may be automated such that the cooked menu items are selected for mixing, combined into a mixture using one or more machines, and shaped using one or more machines in order to produce a processed food composition, in relatively large quantities, that is ready for packaging and distribution as a grocery or specialty food item.

### Conclusion

The systems and methods described herein have been recognized by others in the field as unique, innovative, and unlike anything else. For example, the embodiment known as Dining With Dignity was implemented in an assisted living setting and it received the Best of the Best award for 2014, in the Health and Wellness category, from the Assisted Living Federation of America. As reported the ALFA magazine, Senior Living Executive, the systems and methods described herein were described as “a new culinary technique” for creating a dish that is “finger-ready, easy to swallow, and as nutritionally complete as the original.” (Senior Living Executive, Vol. 21, No. 3, May/June 2014, at pp. 19-20, www alfa orgy. Food Service Director published an article about the systems and methods described herein in its Ideas & Innovation section, entitled The Big Idea 2014: The Purée Alternative (Jul. 7, 2014; FoodServiceDirector com). In a feature article, Senior Housing News described the systems and methods described herein as “a new approach to dining in memory care” that is “unlike other alternatives.” (4 Techniques on Memory Care's Cutting Edge; 2014, SeniorHousingNews com).

Although several embodiments have been described herein, those of ordinary skill in art, with the benefit of the teachings of this disclosure, will understand and comprehend many other embodiments and modifications for this technology. The invention therefore is not limited to the specific embodiments disclosed or discussed herein, and that may other embodiments and modifications are intended to be included within the scope of the appended claims. Moreover, although specific terms are occasionally used herein, as well as in the claims that follow, such terms are used in a generic and descriptive sense only, and should not be construed as limiting the described invention or the claims that follow.

1. A method of preparing a processed food composition for independent dining, comprising the steps of:
selecting one or more cooked menu items;
combining said one or more cooked menu items into a mixture; and
shaping said mixture into a processed food composition comprising one or more substantially graspable sizes and shapes.

2. The method of claim 1, wherein said one or more cooked menu items comprises a protein food, a carbohydrate food, and a vegetable food, and wherein said step of selecting further comprises:
proportionally selecting said protein, carbohydrate, and vegetable foods from among said one or more cooked menu items such that said processed food composition is substantially nutritionally balanced according to dietary principles.

3. The method of claim 2, wherein said processed food composition comprises:
a protein component in an amount between about 30% to about 60% of the total weight of said processed food composition;
a carbohydrate component in an amount equal to between about 20% to about 40% of the total weight of said processed food composition; and
a vegetable component in an amount equal to between about 20% to about 40% of the total weight of said processed food composition.

4. The method of claim 1, wherein said step of combining comprises one or more food-processing techniques selected from the group consisting of grinding, chopping, blending, shredding, mixing, stirring, puréeing, grating, crushing, and slicing.

5. The method of claim 1, wherein said step of shaping comprises one or more techniques selected from the group consisting of spooning, scooping, molding, wrapping, shaping by hand.

6. The method of claim 1, wherein said step of shaping produces one or more substantially graspable sizes and shapes selected from the group consisting of balls, spheres, egg-shapes, cubes, chunks, cylinders, sticks, strips, and slices.

7. The method of claim 1, wherein said processed food composition may be eaten substantially without utensils and without assistance.

8. A system for preparing a processed food composition for independent dining, comprising:
one or more cooked menu items;
a food processor for combining said one or more cooked menu items into a mixture; and
a shaping tool for forming said mixture into a processed food composition comprising one or more substantially graspable sizes and shapes.

9. The system of claim 8, wherein said one or more cooked menu items comprises a protein food, a carbohydrate food, and a vegetable food, and wherein said system further comprises:
a guide for proportionally selecting said protein, carbohydrate, and vegetable foods such that said processed food composition is substantially nutritionally balanced according to dietary principles.

10. The system of claim 9, wherein said processed food composition comprises:
said protein food in an amount equal to between about 30% to about 60% of the total weight of said processed food composition;
said carbohydrate food in an amount equal to between about 20% to about 40% of the total weight of said processed food composition; and
said vegetable food in an amount equal to between about 20% to about 40% of the total weight of said processed food composition.

11. The system of claim 8, wherein said food processor comprises one or more tools selected from the group consisting of a grinder, chopper, blender, shredder, mixer, grater, crusher, and slicer.

12. The system of claim 8, wherein said shaping tool comprises one or more tools selected from the group consisting of a spoon, scoop, mold, wrap, and hands.

13. The system of claim 8, wherein said one or more substantially graspable sizes and shapes is a shape selected from the group consisting of balls, spheres, egg-shapes, cubes, chunks, cylinders, sticks, strips, and slices.

14. The system of claim 8, wherein said processed food composition may be eaten substantially without utensils and without assistance.
